(19) United States
(12) Patent Application Publication
(10) Pub. No.: US 2026/0067598 A1
(43) Pub. Date: Mar. 5, 2026

(54) TELECOMMUNICATION SYSTEM FOR HYDROLOGY TELEMETRY FIELD OF THE INVENTION

(71) Applicants: LIGHT - SERVIÇOS DE ELETRICIDADE S/A, Rio de Janeiro (BR); ALTUS SISTEMAS DE AUTOMACAO S.A., São Leopoldo (BR)

(72) Inventors: Diego Augusto TIMM, Campo Bom (BR); Douglas Paz RODRIGUES, Porto Alegre (BR); Enio Erny Schulz FILHO, São Leopoldo (BR); Gilberto Aguiar DE ALMEIDA, Alvorada (BR); Humberto Corrêa KRAMM, Eldorado (BR); Igor Tedeschi FRANCO, Alvorada (BR); Igor Gomes DA SILVA, Gravataí (BR); Joao Antonio Astolfi GONÇALVES, Sao Leopoldo (BR); Leonardo Silva DUTRA, Novo Hamburgo (BR); Rafael LIMA, Novo Hamburgo (BR); Lude Quièto VIANA, Rio de Janeiro (BR); César Augusto Silva DE FARIAS, Rio de Janeiro (BR); Philipe Vasques DA SILVA, Rio de Janeiro (BR)

(21) Appl. No.: 19/314,977

(22) Filed: Aug. 29, 2025

(30) Foreign Application Priority Data
Aug. 30, 2024 (BR) 10 2024 017896 3

(51) Int. Cl. H04Q 9/00; H04L 67/12

(52) U.S. Cl. CPC H04Q 9/00; H04L 67/12

(57) ABSTRACT

The present invention relates to a telecommunication system for hydrology telemetry that allows data collection with redundant communication interfaces, including LoRa and Ethernet communication interfaces. It allows real-time remote monitoring of hydrological information and ensures the use of another communication medium as a redundant medium in the event of failure, increasing the availability of hydrological information in the system.

The present invention is applicable in hydrology or other telemetry areas, enabling data collection with redundant communication interfaces including LoRa and Ethernet communication interfaces. It allows remote monitoring of hydrological information in real time and makes it possible to use another means of communication as a redundant means in the event of failure, increasing the availability of hydrological information in the system.

### BACKGROUND OF THE INVENTION

Current hydrology data measurement and transmission solutions require expensive data transmission infrastructures, as well as extra equipment such as converters, radios, PLCs and SCADAs to concentrate data. In addition, the solutions generally do not use physical media redundancy for data transmission, which makes data unavailable in the event of a simple transmission failure.

Document BR 10 2021 016758 0 describes a non-hydrological unavailability monitoring system for small hydroelectric power plants. This is a non-hydrological unavailability monitoring system (100) for a small hydroelectric power station comprising a supervision system (10); a recording computer (20); at least two upstream level sensors and at least two downstream level sensors for monitoring dam levels upstream and downstream of the turbines; at least two tilt sensors of a first sluice gate for monitoring the opening of the first sluice gate, and at least two tilt sensors of a second sluice gate for monitoring the second sluice gate; at least two position sensors of the first sluice gate and at least two position sensors of the second sluice gate; at least one full-closure electrical switch of the first sluice gate and at least one full-closure electrical switch of the second sluice gate; at least one main meter for power control and monitoring (30) and at least one backup meter for power control and monitoring (40); a main electrical panel comprising a data reading device (50) for reading data from the sensors and performing variable calculations, a data acquisition device (90), and a power management system; and a remote electrical panel comprising an Ethernet/IP adapter (70) and a power management system (80). This system only uses the Ethernet communication interface and has no redundancy, meaning that if the Ethernet interface fails, the entire system fails.

The document BR 10 2019 003180 8 describes a process and system of hydrological analysis and management for basins. Hydrological analysis and management process and system for basins with networks of weather stations and artificial drainage systems with management of natural and artificial dams by means of locks and pumping stations. It assesses the potential for water risk in each area and analyzes the possible consequences of future precipitation a priori through simulations. For this simulation, hydrographs are calculated for each sub-basin, channels and rivers in the basin. It simulates the behavior of the basin under different scenarios corresponding to different management of the operation of the gates and/or pumps, and compares their results in terms of loss of flooded area, economic loss of each sector, loss due to flooding of inhabited areas, etc. Optimizing the simulation through AI (Artificial Intelligence, meta-heuristic algorithms, neural networks, etc.) allows it to serve as a search engine to find better solutions, the best resource management configuration to minimize the socio-economic impact on the basin. This system does not provide for the combined use of Ethernet and LoRa communication interfaces and has no redundancy, meaning that if a communication interface fails, the entire system fails.

Document BR 10 2017 003102 0 A2 describes an automatic integrated hydrological analysis system for the injection of dye tracers. Through the integration of computer and electronic intelligence, the system aims to make it possible to reconcile knowledge about recording, reading and analyzing rainfall intensity with the release of dye tracers on the surface of the terrain. The system allows the intensity of rainfall to be recorded, read, analyzed and configured, which in turn can trigger a command for an electro-mechanical valve hydraulically connected to the reservoir to be activated (opened), releasing the dye tracers that will move at the times deemed appropriate for their movement with the rainfall. The system consists of a central module (B) which has the function of interacting with all the peripheral components, and which also stores data obtained from the rain gauge (6) and transmits the stored data remotely via GSM/GPRS using a SIM card installed in the central module (1) with the aid of an antenna (3). The programming is generated on the computer, assigning the opening of the electromechanical valve assembly (2), equipped with a mechanical actuator (9) and register (10), to the condition of a certain volume of rain in a set time. This system uses communication via a cellular interface and also does not provide for the combined use of Ethernet and LoRa communication interfaces and does not have redundancy, meaning that if a communication interface fails, the entire system fails.

Document CN 111141367 describes a water level monitoring node based on LoRa and a hydrological telemetering system. The monitoring node consists of a microcontroller for data processing and transmission, an ultrasonic sensor for distance measurement, an RF LoRa module, an antenna, a magnetic switch and a power supply module. And the LoRa RF module sends the device's status information to a base station via the antenna, and the base station sends the status information to a server. Compared to traditional GPRS communication technology, the LoRa-based water level monitoring node and hydrological telemetering system have advantages: the transmission distance range is expanded, the transmission power consumption is reduced, the cost is greatly reduced; and the LoRa-based water level monitoring node and hydrological telemetering system are suitable for popularization and application. This system uses communication via the LoRa interface and also does not provide for the combined use of Ethernet and LoRa communication interfaces and does not have redundancy, meaning that if a single communication interface fails, the entire system fails.

Document CN111397584 describes a hydrological monitoring system and method. The system comprises a hydrological monitoring device, a control chip, a LoRa wireless communication device, a solar power generation device, a storage battery, and a light sensor. The solar power generation device and the storage battery are respectively connected to the hydrological monitoring device, the light sensor, and the LoRa wireless communication device. The hydrological monitoring device is used to monitor hydrological data. The control chip is configured to control the solar power generation device to supply power when the light intensity detected by the light sensor is greater than or equal to a predefined illumination intensity value. The control chip is further configured to control the storage battery to supply power when the light intensity detected by the light sensor is lower than the predefined illumination intensity value. The control chip is also configured to control the LoRa wireless communication device to transmit the hydrological data monitored by the hydrological monitoring device and the electrical charge information of the storage battery. The hydrological monitoring system and the hydrological monitoring method can be suitable for hydrological monitoring in remote field areas with inconvenient power supply. This system uses communication via the LoRa interface and also does not provide for the combined use of Ethernet and LoRa communication interfaces and does not have redundancy, meaning that if a single communication interface fails, the entire system fails.

### SUMMARY OF THE INVENTION

The aim of the present invention is to provide a low-cost solution for telemetry systems for transmitting hydrology data in real time that have integrated communication interfaces such as the LoRa Radio and Ethernet interface. In addition, these interfaces can operate redundantly to increase the availability of hydrological data to be transmitted by telemetry systems.

One of the advantages of the present invention is to integrate LoRa and Ethernet interfaces directly into a datalogger.

In addition, it allows them to be used together, which guarantees greater availability through redundancy.

THE LoRa network, although not used as much for high availability, was used with gateways and network servers operating redundantly, which guarantees greater availability of this network in the face of transmission errors or failures in network elements.

In addition, the web application for hydrology was developed to work transparently with the communication medium, as well as being scalable, requiring no changes to the source code to add new stations or sensors to the system.

The main features of the system of the present invention are:
Use of a datalogger to measure hydrological data with Ethernet and LoRa communication interfaces integrated directly into the same device;
Ability of Ethernet and LoRa interfaces to be used as redundant interfaces that operate in a complementary manner in the event of failure of one of them taking over the other, increasing system availability; and
Redundancy of the LoRa Network with pairs of redundant Gateways, as well as redundancy of the Network Servers.

### DESCRIPTION OF THE FIGURES

FIG. 01 illustrates a diagram of the present invention.

FIG. 02 illustrates the block diagram of the system of the present invention.

FIGS. 03 and 04 illustrate the flowcharts of the hydrological measurement method implemented by the system of the present invention.

### DETAILED DESCRIPTION OF THE INVENTION

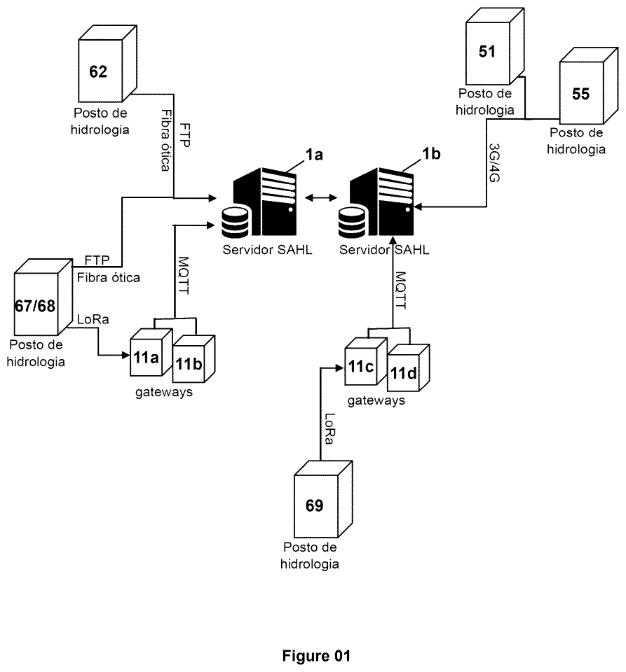

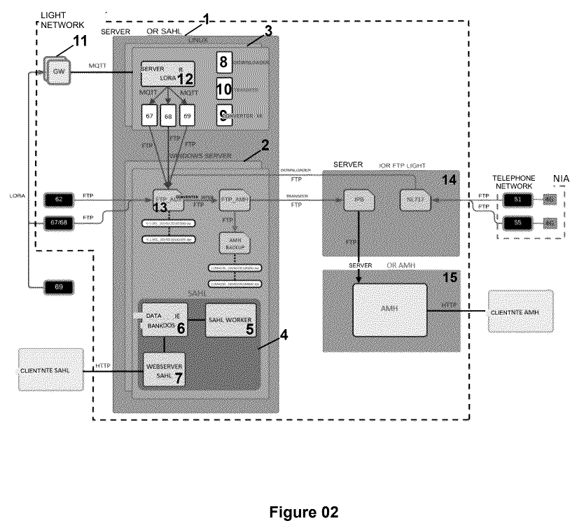

The invention is a hydrological measurement system with high data availability. FIGS. 01 and 02 show the system.

THE architecture consists of two redundant physical servers (1a) and (1b), represented in FIG. 02 by a block with the description SAHL Server (1). These physical servers run SAHL services directly on the Windows Server operating system, identified in FIG. 02 as a blue rectangle duplicated with the name Windows Server (2), and host a Linux virtual machine, identified in FIG. 02 as an orange rectangle duplicated with the name Linux (3). SAHL (4) (acronym for Sistema de Análise Hidrológica da Light) is a hydrology software program, shown in FIG. 02 inside Windows Server in dark green, which aims to store data from hydrological stations, such as river levels, rainfall and system diagnostics. It calculates other quantities such as flow and sends the information to regulatory bodies such as the ANA and ONS. The system consists of a service called SAHL Worker (5), identified in FIG. 02 by this name, which monitors a specific folder on the physical server. When a file is received in this folder, either directly or through auxiliary scripts, the service consumes the file, analyzes it and sends the data to the SQL Server database (6), identified in FIG. 02 as the Database. The SAHL front-end is a web application (7), shown in FIG. 02 SAHL Webserver, which allows you to query and configure the system by accessing the local IP of the physical server on port 8080.

On each physical server (1a and 1b), there is a Linux virtual machine (3). They are responsible for executing all the scripts for downloading (8) (FtpFilesDownloader.sh), converting (9) (FileFormatConverter.sh) and sending (10) (FtpFilesTransfer.sh) the files containing hydrology data from each monitoring station. The data flow is represented in FIG. 02 by a purple, green and blue arrow respectively.

The hydrology station is equipped with a datalogger, such as the Nextologger NL717 model, represented by blocks with the numbers 51, 55, 62, 67/68 and 69, responsible for reading the values measured by the river level and rain sensors. The datalogger runs an application that collects the data every 15 minutes, assembles a file in .dat format (for FTP transfer) and sends it via different technologies: fiber optics for stations 62 and 67/68, LoRa for stations 67/68 and 69 and a cell phone network for stations 51 and 55. If communication fails when sending, the file is saved in a queue and sent as soon as communication is available. In the case of stations using LoRa (stations 69 and 67/68), a LoRa gateway (11) is still required, such as the GW700 model, represented in FIG. 02 by a rectangle with the name GW.

THE integration of the NL717 datalogger with the LoRa GW700 gateway takes place as follows: on the datalogger, there is an application that sets up a payload containing the hydrology data. There is an application routine that sends this payload via LoRa to the GW700 gateway (11). To enter this data into the system, the LoRa server (12) creates an MQTT topic, where the GWL00 gateway (11) publishes the payload. A script subscribes to this topic, receives the values and organizes them in a file in the standard SAHL format. This file is then sent by FTP to the Windows Server (2) where SAHL is located, the sequence shown in FIG. 02 in the flow that leaves the LoRa Server (12) on Linux and arrives in the FTP_AUX folder (13) on the Windows Server (2).

In the system in FIG. 02 there are four GW700 gateways (11a, 11b, 11c, 11d) installed in the system. For redundancy reasons, two of them are registered on the primary LoRa server (12) and two on the secondary LoRa server (12). This demonstrates the redundancy of the LoRa network. If one of the gateways fails, there is a pair that keeps the communication going. In this case there is no synchronization between the gateways (11). The data is sent to the two gateways (11) and one of them will receive the data and send it to the Linux server (3).

In addition, there is a Lora server (12) operating in the VM, in FIG. 02 represented by the beige rectangle with the name LoRa Server, where the readings of the posts configured in this format are received. The front-end of the Lora servers for configuration and monitoring can be accessed via the local IP of the Linux server (3) on port 8080. If the gateways (11) fail, this failure can be diagnosed via this interface. The values arrive via a payload containing sensor data and other information, and are published in an MQTT topic generated by the LoRa server (12). Synchronization takes place because only the LoRa server (12) of the active Physical server (1) is running.

So the Physical servers (1a and 1b) perform an algorithm that synchronizes which of the two Physical servers is active and uses this to start or stop the LoRa server (12). Synchronization of the databases (6) between the pair of physical servers (1a and 1b) is used to synchronize the hydrology system data.

The high availability of data is also due to the fact that the data collector, the datalogger, has integrated wireless communication and an ethernet network. FIG. 02 shows post 67/68 connected to the LoRa network and directly to the Ethernet network via the FTP protocol. These interfaces operate redundantly, sending data via both means, which ensures that if one of the interfaces fails, the one that hasn't failed can continue sending data. The sending is duplicated and if both files are successfully sent, the hydrology software realizes that it is the same data and discards the one that arrives last. This implies two of the most widely used techniques for increasing the availability of systems: redundancy and diversity. As the wireless communication option used is the LoRa network, in order to increase its availability, redundancy techniques are also used in the communication arrangement, as mentioned above. Using two Lora network and application servers that are physically separated on different equipment. In addition, for each of the Lora servers, a pair of LoRa gateways are used. In this way, simple failures in the Lora servers, gateways, or the data collector's means of communication can be remedied through the redundancies available.

The system also consists of hydrology software. It provides a standardized web interface that communicates identically for stations with different means of communication. In this way, new stations and sensors can be added without the need for code changes, allowing the system to be scaled in a much more viable way and at a lower operating cost, differentiating it from market systems.

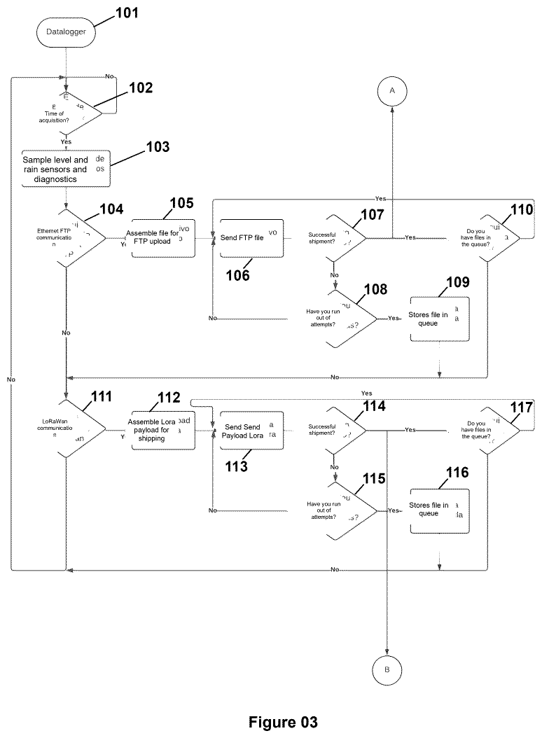

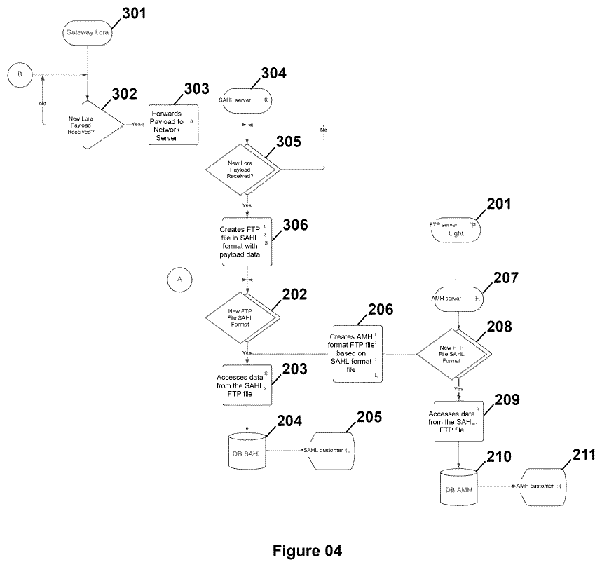

FIGS. 03 and 04 illustrate the hydrological measurement method implemented by the system of the present invention.

Taking into account that all the equipment at the hydrological stations, servers and software and applications are fully operational, the method starts at the datalogger (101) with a check of the acquisition time (102), if positive, the datalogger application collects the samples from the level and rain sensors and the diagnostics (103).

The application checks whether the hydrological station is communicating via ethernet, if so, the datalogger application sets up a file to send the sample data via FTP (105) and sends the file (106).

The application checks if the upload was successful (107), if not, it tries to upload again until the pre-established number of attempts is exhausted (108), if this number is exhausted, the application saves the file in a queue for later upload (109), if so, it checks if there are files in the queue to be uploaded (110), if so, it goes back to the FTP file upload step (106).

If not, the datalogger application checks for communication via LoRa (111), if so, it assembles the LoRa payload for sending (112) and sends the LoRa payload (113).

The application checks if the upload was successful (114), if not, it tries to upload again until the pre-established number of attempts is exhausted (115), if this number is exhausted, the application saves the file in a queue for later upload (116), if so, it checks if there are files in the queue to be uploaded (117), if so, it goes back to the FTP file upload step (113).

If not, i.e. no more files to be sent, the datalogger application checks again whether it is time to acquire new data (102).

For successfully sent FTP files (107), these are received on the LIGHT FTP server (201). The LIGHT FTP server application (201) confirms the format of the received file in SAHL format (202) and follows two procedures in parallel:
processes the data from the FTPSML files (203) and stores it in a database (204) making the data available to the SAHL client (205); and
creates MHH format FTP file based on SAHL format file (206) and transmits this file to the AMH server (207) and confirms that the file is in AMH format (208), processes the data from the AMH FTP file (209) and stores it in a database (210) making the data available to the AMH client (211).

For successfully sent LoRa files (114), these are received at the LoRa gateways (301). The gateway application checks whether the file received is a new LoRa payload (302), if not, it checks again whether there is a file in the queue (117), if so, it forwards the payload to the network server (303) of the SAHL server (304) and confirms that it is a new LoRa payload (305), if not, waits for a new file, if so, creates an FTP file in SAHL format with the payload data (306) and sends this file to the LIGHT FTP server (201) and the LIGHT FTP server application (201) confirms the format of the file received in SAHL format (202) following the next steps (203) to (211).

The system continues to perform all the above steps while the system is running.

1. Telecommunication system for hydrology telemetry characterized by containing two redundant physical servers (1a) and (1b), where these physical servers run the SAHL software services directly on the Windows Server operating system and host a Linux virtual machine (3) responsible for running all the download scripts (8), conversion (9) and sending (10) of the files containing hydrology data from each monitoring station, and where the two physical servers (1a and 1b) run an algorithm that synchronizes which of the two physical servers will be active and uses this to start or stop the LoRa server (12), and to synchronize the data from the hydrology system it uses the synchronization of the databases (6) between the pair of physical servers (1a and 1b),
a hydrology software called SAHL (4) (acronym for Light Hydrological Analysis System) running on Windows Server that stores the data from the hydrological stations, such as river level, rainfall and system diagnostics, The SAHL software calculates other quantities such as flow and sends the information to regulatory bodies, and this hydrology software has a standardized web interface that communicates identically to stations with different means of communication, allowing new stations and sensors to be added without the need for code changes.
a service called SAHL Worker (5) that monitors a specific folder on the physical server and when a file is received in this folder, either directly or through auxiliary scripts, the service consumes the file, analyzes it and sends the data to the SQL Server database (6),
a web application (7) on the SAHL front-end that allows the system to be consulted and configured by accessing the local IP of the physical server on port 8080,
hydrology stations (51), (55), (62), (67/68) and (69) equipped with a datalogger responsible for reading the values measured by the river level and rainfall sensors, and the datalogger runs an application that collects the data from the sensors every 15 minutes, assembles a file in .dat format, in the case of FTP transfer, and sends it via fiber optics, LoRa and/or the cell phone network, and, in the event of a communication failure when sending the file, this file is saved in a queue and sent as soon as communication is available, and the dataloggers are equipped with wireless communication and an integrated ethernet network
two LoRa gateways (11), working in redundancy, at each monitoring station that uses the LoRa communication protocol, where the datalogger integrates with the LoRa gateways (11) by means of an application that assembles a payload containing the hydrology data and an application routine sends this payload via LoRa to the gateways (11) to enter this data into the system, the LoRa server (12) creates an MQTT topic, where the gateways (11) publish the payload, a script subscribes to this topic, receives the values and organizes them in a file in the standard format of the SAHL software, this file is then sent by FTP to the FTP_AUX folder (13) on the Windows Server (2), where the gateways, for redundancy reasons, two of them are registered on the primary LoRa server (12) and two on the secondary LoRa server (12), in the event of failure of either gateway, there is a pair that keeps the communication running without synchronization between the gateways (11) and the data is sent to the two gateways (11) and one of them receives the data and sends it to the Linux server (3),
a LoRa server (12) operating on each physical server, where the readings of the posts configured in this communication format are received, and these are equipped with a front-end for configuration and monitoring accessible via the local IP of the Linux server (3) on port 8080, and in the event of a failure of the gateways (11) this failure can be diagnosed via this interface, and the values arrive via a payload containing the sensor data and other information, They are published in an MQTT topic generated by the LoRa server (12), and synchronization takes place due to the fact that only the LoRa server (12) of the active Physical server (1) is running the SAHL software, and
where in the hydrology stations equipped with communication via the LoRa network and via the ethernet network through the FTP protocol, these interfaces operate redundantly, sending the data by both means, ensuring that if one of the interfaces fails, the one that didn't fail continues sending the data, the sending is duplicated and if both files are successfully sent, the SAHL hydrology software detects that it is the same data and discards the one that arrives last.

2. Method of hydrological control, applied with the system defined in claim 1, characterized in that it comprises the following steps:
Connect all hydrological station equipment, servers and system software and applications,
Start the datalogger (101) to check the acquisition time (102); if this is positive, the datalogger application collects the samples from the level and rain sensors and the diagnostics (103),
Check with the application whether the hydrological station is communicating via ethernet, if so, the datalogger application sets up a file to send the sample data via FTP (105) and sends the file (106),
Check with the application if the upload was successful (107), if not, try to upload again until the pre-established number of attempts is exhausted (108), if this number is exhausted, the application saves the file in a queue for later upload (109), if so, check if there are files in the queue to be uploaded (110), if so, go back to the FTP file upload step (106),
If not, the datalogger application checks for communication via LoRa (111), if so, assembles the LoRa payload for sending (112) and sends the LoRa payload (113),
Check with the application if the upload was successful (114), if not, try to upload again until the pre-established number of attempts is exhausted (115), if this number is exhausted, the application saves the file in a queue for later upload (116), if so, check if there are files in the queue to be uploaded (117), if so, go back to the FTP file upload step (113),
If not, i.e. there are no more files to send, the datalogger application checks again to see if it is time to acquire new data (102),
For successfully sent FTP files (107), these are received on the LIGHT FTP server (201), the LIGHT FTP server application (201) confirms the format of the received file in SAHL format (202) and follows two procedures in parallel:
processes the data from the SAHL FTP files (203) and stores it in a database (204) making the data available to the SAHL client (205); and
creates an AMH format FTP file based on the SAHL format file (206) and transmits this file to the AMH server (207) and confirms that the file is in AMH format (208), processes the data from the AMH FTP file (209) and stores it in a database (210) making the data available to the AMH client (211),
For successfully sent LoRa files (114), these are received at the LoRa gateways (301),
The gateway application checks if the file received is a new LoRa payload (302), if not, it checks again if there is a file in the queue (117), if so, it forwards the payload to the network server (303) of the SAHL server (304) and confirms that it is a new LoRa payload (305),
If not, waits for a new file, if so, creates an FTP file in SAHL format with the payload data (306) and sends this file to the LIGHT FTP server (201) and the LIGHT FTP server application (201) confirms the format of the file received in SAHL format (202) following the next steps (203) to (211),
The system continues to perform all the above steps for as long as the system is running.
